(19) United States
(12) Patent Application Publication
(10) Pub. No.: US 2006/0110491 A1
(43) Pub. Date: May 25, 2006

(54) Systems and methods for mixing fluids and other materials

(76) Inventor: Richard E. Parks, Bellevue, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/246,539

(22) Filed: Oct. 7, 2005

Related U.S. Application Data
(63) Continuation-in-part of application No. PCT/US04/11248, filed on Apr. 8, 2004.
(60) Provisional application No. 60/461,470, filed on Apr. 8, 2003.

(51) Int. Cl. C12C 11/00

(52) U.S. Cl. 426/11

(57) ABSTRACT

A system for breaking a cap generated during vinification and for mixing the fermenting juice in a tank includes an injector to inject gas into the tank to form a bubble in the fermenting juice, a source of gas to supply the injector, and a controller operable to open and close the injector. The controller comprises a memory operable to store a mixing recipe that includes instructions for opening and closing the injector, and a processor operable to retrieve the mixing recipe from the memory and open and close the injector according to the mixing recipe's instructions. The bubble moves through the fermenting juice urging portions of the juice to flow relative to other portions. The juice that flows adjacent the cap shears the cap at the juice cap interface to break the cap into smaller portions. In addition, the bubble may pierce through the cap or cause the cap to tip into the fermenting juice to also break the cap into smaller portions.

### CROSS-REFERENCE TO RELATED APPLICATIONS

This application is a continuation of the PCT Application No. PCT/US2004/011248 titled SYSTEMS AND METHODS FOR MIXING FLUIDS AND OTHER MATERIALS and filed 8 Apr. 2004, which is hereby incorporated by reference, that claims priority from U.S. Provisional Patent Application 60/461,470, titled A SYSTEM, INCORPORATING A PROGRAMMABLE CONTROL UNIT, FOR INJECTING GAS INTO A CONTAINER TO MIX THE CONTENTS THEREIN and filed 8 Apr. 2003. This application claims the benefit of the filing date of the PCT Application under 35 USC §120. This application also claims priority from the U.S. Provisional Patent Application 60/461,470, which is hereby incorporated by reference in its entirety.

### BACKGROUND

Vinification is a process of making wine by fermenting the juice of a fruit, for example grapes, with other ingredients. The vinification process for making wine from grapes typically includes crushing grapes to separate the grape's juice from the other components of the grapes, for example the skins and pulp, and fermenting the grape juice with the grape's other components in a tank. To assist the fermentation, ingredients, for example sugar to increase the alcohol content of the wine, may be added during fermentation and mixed with the other ingredients in the tank to disperse the added ingredient throughout the fermenting juice. As the juice and other grape components ferment, the skins and pulp coalesce to form a cap on top of the fermenting juice. To extract the tannins—compounds that give a wine body and complexity, and soften an aged wine—from the skin and otherwise assist the fermentation of the juice, the cap is broken into portions, and may or may not be aggressively mixed with the fermenting juice. The cap may be broken once during the fermentation of the juice or the cap (or portions thereof may be periodically broken while the juice ferments.

A common method for mixing the fermenting juice to disperse added ingredients is to stir the fermenting juice with a handheld paddle or mechanical stirrer. If one uses a handheld paddle, one typically opens the tank, inserts the paddle into the fermenting juice and moves the paddle to stir the fermenting juice. If one uses a mechanical stirrer, one typically opens the tank, inserts a stirring end into the fermenting juice and turns on a motor that moves the stirring end. Other mechanical stirrers may include a stirring end located in the tank throughout the fermentation process.

A common method for breaking the cap includes inserting a paddle into the tank and mixing the contents of the tank. To perform this method, one typically opens the tank at the desired time and strikes the cap with the paddle to break the cap into portions. If the vinification process requires aggressively mixing the cap portions with the fermenting juice, then one stirs fermenting juice and cap portions to disperse the cap portions throughout the juice. In addition, if ingredients are added at this time, one mixes the fermenting juice.

Another common method for breaking the cap includes pouring the fermenting juice over the cap. To perform this method, one typically opens the tank at the desired time and pumps juice, typically from the bottom of the tank, over the top of the cap. The force of the juice falling on top of the cap breaks the cap into portions and mixes the poured juice with the cap portions. If the vinification process requires aggressively mixing the cap portions with the fermenting juice, then one continues to pour the fermenting juice into the top of the tank.

Unfortunately, these methods are not the most efficient methods for mixing the fermenting juice and breaking the cap. Mixing the fermenting juice by moving a paddle through the juice or stirring end of a mechanical stirrer through the juice requires one to generate enough power to overcome the juice's inertia and resistance to shear. i.e. vicosity, to move the juice. If the tank is large and holds a large amount of juice, the power required to disperse the added ingredient or cap portions throughout the fermenting juice can be significant. Breaking the cap with a handheld paddle also requires one to provide the power to overcome the bond attaching the grape skins to each other. And pouring fermenting juice onto the top of the cap requires one to supply power to a pump to raise the juice above the cap and expel the juice at a desired velocity.

Furthermore, the methods for mixing the fermenting juice and breaking the cap require one to know the time when the mixing or breaking should occur in the vinification process, and perform the mixing and/or breaking. Consequently, a staff of personnel is typically required to attend to the fermentation process, which increases the production cost of the wine.

### SUMMARY

In one aspect of the present invention, a system for breaking a cap generated during vinification comprises an injector to inject gas into the tank to form a bubble in the fermenting juice. The bubble moves through the fermenting juice urging portions of the juice to flow relative to other portions. The juice that flows adjacent the cap shears the cap at the juice cap interface because the tank prevents the cap from moving with the flow of juice. Thus, the flow of juice breaks the cap into smaller portions. In addition, when the bubble eventually reaches the cap the bubble may pierce through the cap or cause the cap to tip into the fermenting juice to also break the cap into smaller portions. The system also comprises a source of gas to supply the injector, and a controller operable to open and close the injector. The controller comprises a memory operable to store a mixing recipe that includes instructions for opening and closing the injector, and a processor operable to retrieve the mixing recipe from the memory and open and close the injector according to the mixing recipe's instructions.

In another aspect of the invention, the system may automatically mix the fermenting juice in the tank. This may be desirable to disperse an ingredient added to the fermenting juice during the fermentation process.

Because gravity causes the bubble to rise through the contents of the tank one does not have to generate power to move the bubble through the contents. The power one needs to generate is the power required to inject gas into the tank. Thus, the system is more efficient because it uses less power than conventional mixing and cap breaking techniques. Furthermore, because a controller opens and closes the injector according to a mixing recipe, one can reduce the number of staff required to attend to the fermentation process.

### BRIEF DESCRIPTION OF THE FIGURES

FIG. 1 is a perspective view of a system for injecting gas into a tank to generate bubbles in the material held by the tank, according to an embodiment of the invention.

FIG. 2A is a perspective view of a tank holding ingredients fermenting to make wine and shows bubbles generated by the system of FIG. 1 moving through the ingredients to break the cap and mix the ingredients, according to an embodiment of the invention.

FIG. 2B is a plan view of the tank in FIG. 2A showing the flow of juice underneath the cap caused by the bubbles.

FIG. 3 is a block diagram of a controller that is incorporated in the system of FIG. 1, according to an embodiment of the invention.

FIG. 4 is a flowchart of a process for generating a mixing recipe that the system of FIG. 1 may follow to break the cap in the tank.

FIG. 5 is a flowchart of a process for generating a mixing recipe that the system of FIG. 1 may follow to mix the ingredients in the tank.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

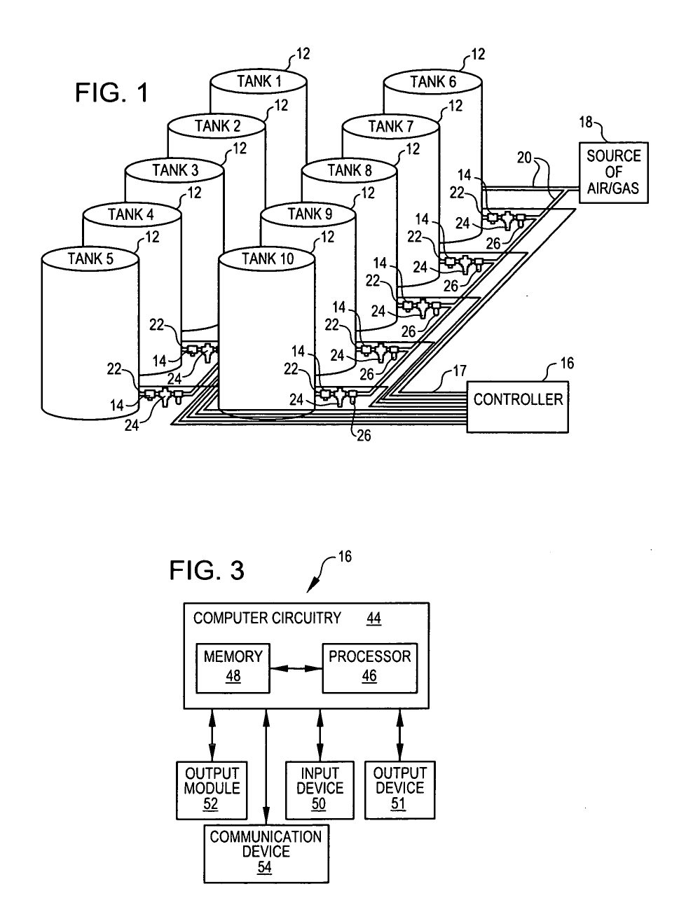

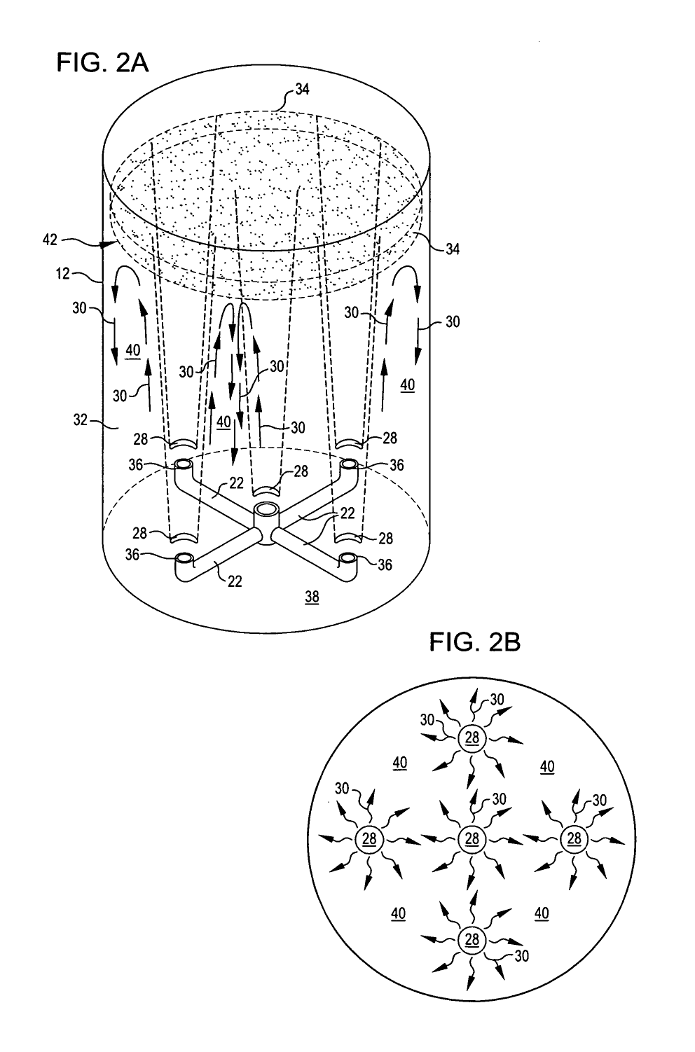

FIG. 1 is a perspective view of a system 10 for injecting gas into a tank 12 (here ten tanks) to generate one or more bubbles in the material held by the tank 12, according to an embodiment of the invention. Here, each tank 12 contains ingredients, which includes juice (shown in FIGS. 2A and 2B) fermenting to make wine, but each tank 12 may contain other materials that require periodic mixing or cap breaking, for example oils or sour mash. The one or more bubbles (discussed in greater detail in conjunction with FIGS. 2A and 2B) move through the fermenting juice and generate flows of juice within the tank 12 that can break a cap (shown in FIG. 2A) formed during fermentation into smaller portions. When the one or more bubbles reach the cap, the one or more bubbles may pierce through the cap or cause the cap to tip into the fermenting juice to also break the cap.

The system 10 includes an injector 14 (here ten but only 7 shown; each corresponding to a tank 12) to inject gas, which may be air or any other desired gas, into the fermenting juice, and a controller 16 (discussed in greater detail in conjunction with FIG. 3) coupled to the injectors 14 with cable 17 and that opens and closes the injectors 14 according to a mixing recipe. The system 10 also includes a source of gas 18, and distribution lines 20 to supply the injectors 14 with the gas.

Because gravity causes the one or more bubbles to rise through the fermenting juice in the tanks 12 one does not have to generate power to move the one or more bubbles through the juice. The generated power that the system 10 does require is the power required to inject gas into the tanks 12 and run the controller 16. Thus, the system 10 uses less power than conventional mixing and cap breaking techniques, and therefore is more efficient. Furthermore, because a controller 16 opens and closes the injector 14 according to a mixing recipe, one can reduce the number of staff required to attend to the fermentation process.

Still referring to FIG. 1, the injectors 14 may be any injector desired capable of injecting gas, and may be located inside the tank 12 or outside the tank 12. For example, in one embodiment, the injectors 14 may be any conventional injector and located outside the tanks 12. Consequently, the distribution lines 20 include line sections 22 each coupling a respective one of the injectors 14 to the inside of a corresponding tank 12. To prevent the fermenting juice inside the tanks 12 from entering the line sections 22, the system 10 includes one or more check valves (shown in FIG. 2A). When the injectors 14 are open to inject gas into the line sections 22, the check valves allow the gas to enter the tanks 12. When the injectors 14 are closed, the check valves prevent the fermenting juice from entering the line sections 22. By locating the injectors 14 outside the tanks 12, one my easily repair or maintain the injectors 14 without having to drain the tanks 12. Thus, one can continue to ferment juice in the tanks 12 while working on the injectors 14.

Other embodiments are contemplated. For example, the injectors 14 may be located inside the tanks 12 and may be as shown and discussed in U.S. Pat. No. 6,629,773 titled Method And Apparatus For Gas Induced Mixing And Blending Of Fluids And Other Materials issued to Mr. Parks on 7 Oct. 2003, which is incorporated herein by this reference.

Still referring to FIG. 1, the system 10 may include additional components. For example, in one embodiment, the system 10 includes a pressure regulator 24 (then here but only 7 shown) to allow one to adjust the pressure of the gas injected by the injectors 14, and thus the volume of gas injected for a given injection time (discussed in greater detail in conjunction with FIGS. 2A and 2B). The system 10 also includes a filter 26 (ten here but only 6 shown) to prevent dust or other materials and/or chemicals in the gas from damaging the injectors 14.

In addition, the system 10 may include an accumulator plate (not shown) to help form one or more bubbles in the tanks 12 as discussed in U.S. Pat. No. 6,629,773 and U.S. Pat. No. 4,595,296 titled Method and Apparatus for Gas induced mixing and blending issued to Mr. Parks on 17 Jun. 1986, which is herein incorporated by this reference. The accumulator plate allows the gas injected during an injection interval to combine to form a large bubble, which then moves through the fermenting juice. A larger bubble may be desired to provide the desired flow characteristics in the fermenting juice. For example, as the bubble's size increases, the bubble's rate of travel through the fermenting juice decreases, and the amount of juice the bubble urges to flow increases. When the accumulator plate is located near the check valves, the gas injected through the check valves can form a large bubble before moving through the fermenting juice.

FIGS. 2A and 2B are views of bubbles 28 generated by the system 10 in FIG. 1 and flows (shown as arrows, thirteen of which are labeled as 30 for reference) of fermenting juice 32 that the bubbles 28 generate in the tanks 12 to break the cap 34 and mix the juice 32, according to an embodiment of the invention. FIG. 2A is a perspective view of a tank 12 holding the juice 32 and cap 34, and shows the bubbles 28 moving through the juice 32 toward the cap 34, and FIG. 2B is a plan view of the tank in FIG. 2A showing the flows 30 of juice 32 underneath the cap 34. As previously discussed herein and discussed in greater detail in U.S. Pat. Nos. 6,629,773 and 4,595,296, the movement of the one or more bubbles 28 through the fermenting juice 32 urges portions of the juice to flow within the tank 12. These flows 30 of juice 32 can be used to break the cap 34 formed during fermentation and disperse an ingredient (not shown) added to the fermenting juice 32. The characteristics of these flows determine the manner in which the cap is broken into smaller portions and the added ingredient is dispersed; and largely depend on the spatial and temporal relationships between each bubble 28 generated by the system 10.

The spatial relationship between each bubble 28 can be any desired relationship to promote breaking the cap 34. For example, in one embodiment, the check valves may be located at or near the bottom 38 of the tank 12 in a pattern resembling an “x”. If each check valve 36 releases gas into the fermenting juice at substantially the same time, the flows 30 of juice 32 generated by the bubbles 28 moving toward the cap 34 substantially circulate in four circulation zones 40. As shown in FIG. 2A, when the flows 30 in each circulation zone 40 contact the cap 34 the flows 30 turn and move substantially parallel to the cap 34. Because the tank 12 prevents the cap 34 from moving with the flows 30, and the flows 30 move in different directions relative to the cap 34, the flows 30 generate shear across portions of the cap's bottom surface 42. At these portions of the cap's bottom surface 42, this shear tends to erode the cap 34 and generate cracks through the cap 34 to break the cap 34 into smaller portions. Then, to help break the cap 34, each bubble 28 exerts pressure on the cap 34 when the bubble 28 reaches the cap 34. Thus, the combination of the shear generated by the flows 30 of fermenting juice and the pressure exerted by the bubbles 28 when they reach the cap 34 breaks the cap 34 into smaller portions whose size largely depends on the spatial relationship of the bubbles.

Other embodiments are contemplated. For example, the check valves 36 may be located away from the bottom 38, and thus closer to the cap 34, and form a pattern resembling substantially concentric rings like a target one may use to practice one's marksmanship. In another example the number of check valves 36 located in a tank 12 may be more or less than five. In yet another example, the check valves 36 and line sections 22 may move in the tank, for example rotate relative to the tank's bottom 38, as gas is injected into the fermenting juice 32.

Still referring to FIGS. 2A and 2B, the temporal relationships between each bubble 28 includes the time between forming successive bubbles 28 from the same check valve 36 to form pulses of bubbles 28, and the timing of bubble pulses from one check valve 36 relative to the bubble pulses of another check valve 36. To form a pulse of bubbles from a single check valve 34, the controller 16 (FIG. 1) opens the injector 14 for a period of time; closes the injector for another period of time and then re-opens the injector 14. Each period of time that the injector 14 is open is the injection time, and the frequency of the injection times is the pulse rate.

The injection time and pulse rate may be any desired duration and the relative timing between bubble pulses from different check valves may be any period of time desired. For example, in one embodiment, the injection time is 0.5 seconds, the pulse rate is 6 pulses per minute, and the timing between bubble pulses from different check valves is substantially zero—that is, the bubbles 28 from each check valve 36 are formed in the fermenting juice at substantially the same time. To increase the shear on the cap 34 caused by juice flowing in the tank 12 and to increase the pressure each bubble 28 exerts on the cap 34 when the bubble 28 reaches the cap 34, the injection time and/or the pulse rate may be increased. Also, adjusting the pressure regulator 24 (FIG. 1) to increase the pressure of the gas injected into the fermenting juice 32 increases the shear and pressure exerted on the cap 34. Thus, the system 10 can be used to efficiently break different sized caps 34, and mix fermenting juices having different viscosities, or fermenting in tanks with different heights.

FIG. 3 is a block diagram of a controller 16 that is incorporated in the system 10 of FIG. 1, according to an embodiment of the invention. The controller 16 opens and closes the injectors 14 (FIG. 1) according to a mixing recipe. The controller 16 includes computer circuitry 44, which includes a processor 46 and a memory 48 coupled to the processor 46, for executing software, which includes one or more mixing recipes, to perform desired calculations, and open and close the injectors 14. As the circuitry 44 executes software, the memory 48 stores some or all of the instructions and data included in the mixing recipes, and the processor 46 retrieves the instructions and data, and opens and closes the injectors 14 accordingly. The controller 16 also includes one or more input devices 50 that are coupled to the computer circuitry 44 and allow one to input data thereto, and one or more output devices 51 that are coupled to the circuitry 44 to provide one data generated by the circuitry 44. The controller 16 also includes an output module 52 to generate a signal that opens or closes the injectors 14, and a communication device 54 to allow one to retrieve data generated by the circuitry 44 or input data to the circuitry 44 over a communications network (not shown). With the controller 16 executing one or more mixing recipes, the system 10 (FIG. 1) can automatically break the cap 34 (FIG. 2A) and mix the fermenting juice, and thus one can reduce the number people required to attend the fermentation process.

The input devices 50, output devices 51 and communication device 54 may be any desired devices capable of performing their desired function. For example, in one embodiment, the input devices 50 include a touch screen having regions that one can touch to input data into the computer circuitry 44 and may also include a keyboard, mouse or microphone. The output devices 51 also include the touch screen and may also include a printer. The communication device 54 includes a modem, which may or may not be wireless, to receive and transmit data to and from the computer circuitry 44 over a communication network such as an intranet or the internet.

Still referring to FIG. 3, the mixing recipes include data and instructions that the processor 46 processes to open and close the injectors 14 to generate a pulse cycle of bubbles 28 (FIGS. 2A and 2B). The data and instructions include information about the injection time and pulse rate for each injector 14, the duration of a pulse cycle, and the time or times during the fermentation process that the system generates a pulse cycle. For example, in one embodiment, a mixing recipe may include data and instructions for starting a first pulse cycle to break the cap 34 (FIG. 2A) 192 hours (8 days) after the juice 32 (FIG. 2A) was placed in the tank 12 (FIGS. 1 and 2A) to ferment, and stopping the first pulse cycle 30 minutes later. The injection time for each pulse in the pulse cycle may be 0.5 seconds, and the pulse rate may be 40 bubbles per second. A second pulse cycle to break the cap again may start 264 hours (11 days) after the juice was placed in the tank 12 to ferment, and stop after 15 minutes. The injection time for each pulse in the second cycle may be 0.3 seconds, and the pulse rate may be 30 bubbles per second. Another mixing recipe may include data and instructions for generating a pulse cycle to mix the fermenting juice to disperse an ingredient added to juice. The pulse cycle may be started by one after the ingredient is added and may be automatically stopped by the controller 10 minutes after staring the cycle. The injection time for each pulse in the pulse cycle may be 1 second, and the pulse rate may be 25 bubbles 28 per second.

Still referring to FIG. 3, with the controller 16, the system 10 can independently inject gas into more than one tank 12 (ten shown in FIG. 1) to generate one or more bubbles 28 in the fermenting juice contained in each tank 12. This may be desirable to simultaneously produce different wines in the group of tanks 12 using different fermenting processes. Furthermore, one can modify each mixing recipe associated with each tank 12 during the fermentation process to allow one to respond to the actual progress of the fermentation process. For example, in one embodiment, one or mixing recipes may be associated with more than one tank 12, and one of the tanks 12 may include two or more injectors 14 that may be independently controlled by the controller 16. In other embodiments, each tank 12 may have one injector 14 to inject gas into the fermenting juice held by the tank, and one mixing recipe associated with the tank 12.

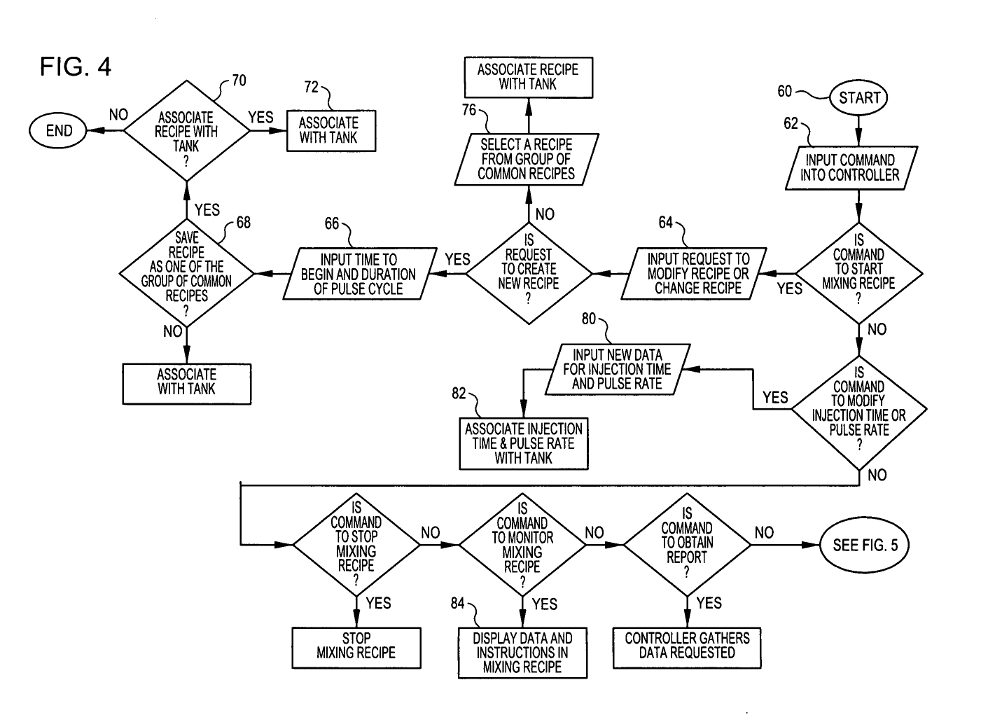

FIG. 4 is a flowchart of a process for generating a mixing recipe that the system of FIG. 1 may follow to break the cap 34 (FIG. 2A) in a tank 12 (FIGS. 1-2B) according to an embodiment of the invention. The following discussion starts, arbitrarily, with the system 10 operating and discusses how one can use the controller to monitor and/or modify a mixing recipe associated with the tank 12, associate a different previously generated mixing recipe with the tank 12, and/or obtain a report on mixing and/or cap breaking pulse cycles the system 10 applied to the contents of the tank 12.

In one embodiment, at step 60, one touches the touch screen display to display the ten tanks 12 coupled with the system 10. Next, one touches a desired tank on the display to monitor and/or modify a mixing recipe associated with the tank 12, to associate a different previously generated mixing recipe with the tank 12, and/or to obtain a report on mixing and/or cap breaking pulse cycles applied to the contents of the tank 12. Then, at step 62, one inputs one of the following commands by touching the touch screen where one of the appropriately labeled blocks are displayed:

Start Mixing Recipe To Break The Cap;

Stop Mixing Recipe For Breaking The Cap;

Monitor Mixing Recipe Associated With Tank;

Obtain Report; and

Modify Injection Time And/Or Pulse Rate.

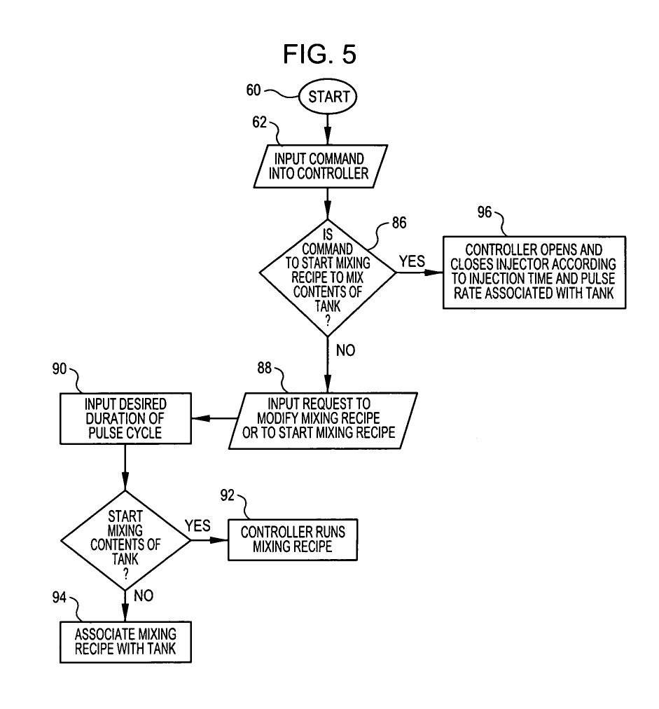

The process for starting the mixing recipe to mix the contents of the tank 12 is discussed in greater detail in conjunction with FIG. 5. If one desires to modify a mixing recipe associated with the tank 12 or associate a different, previously generated mixing recipe with the tank 12, then at step 62 one inputs the Start Mixing Recipe to Break Cap command. Next, at step 64, one selects whether one wants to modify or replace the mixing recipe. If one wants to modify the existing recipe one inputs a Create New Mixing Recipe command by touching the touch screen where the appropriately labeled block is displayed. Then at step 66, one inputs the desired time to begin a pulse cycle and the desired duration of the pulse cycle by touching the touch screen where the appropriately labeled block is displayed. Then at step 68, one decides if one wants to add the new mixing recipe to a group of common mixing recipes accessible to the processor 46 (FIG. 3). If yes, then at step 70 one saves the mixing recipe as a member of the group of common mixing recipes by touching the touch screen where the appropriately labeled block is displayed, and then decides if one wants to associate the mixing recipe with the tank 12. If yes, then at step 72 one associates the mixing recipe with the tank 12 by touching the touch screen where the appropriately labeled block is displayed. If one decides not to add the mixing recipe to a group of common mixing recipes, then, at step 68, one decides if one wants to associate the mixing recipe with the tank 12. If yes, then at step 74 one associates the mixing recipe with the tank 12 by touching the touch screen where the appropriately labeled block is displayed.

If one wants to associate a different mixing recipe with the tank 12, then at step 76 one selects a mixing recipe from the group of common mixing recipes by touching the touch screen where the appropriately labeled block is displayed. Then at step 78, one associates the common mixing recipe with the tank 12 by touching the touch screen where the appropriately labeled block is displayed.

Still referring to FIG. 4, if one wants to modify the injection time and pulse rate of a mixing recipe associated with the tank 12, then at step 62 one inputs the Modify Injection Time and/or Pulse Rate command by touching the touch screen where the appropriately labeled block is displayed. Next at step 80, one inputs the desired injection time and/or pulse rate to be associated with the tank 12, and at step 82 associates this or these with the tank 12, both by touching the touch screen where the appropriately labeled block is displayed.

Still referring to FIG. 4, if one wants to stop the mixing recipe currently associated with the tank 12, then at step 62 one inputs the Stop Mixing Recipe for Breaking the Cap command by touching the touch screen where the appropriately labeled block is displayed. The controller 16 (FIGS. 1 and 3) will then stop running the mixing recipe associated with the tank 12. If the controller 16 is currently opening and closing the injector 14 to generate a pulse cycle in the tank 12 when the Stop Mixing Receipt command is inputted, the controller 16 will stop opening and closing the injector 14.

Still referring to FIG. 4, if one wants to monitor the mixing recipe associated with the tank 12, then at step 62 one inputs the Monitor Mixing Recipe Associated with Tank command by touching the touch screen where the appropriately labeled block is displayed. Then, at step 84 the controller 16 will display the data and instructions of the mixing recipe associated with the tank 12.

Still referring to FIG. 4, if one wants to obtain a report of the pulse cycles the system 10 provided the tank, then at step 62 one inputs the Obtain Report command by touching the touch screen where the appropriately labeled block is displayed.

FIG. 5 is a flowchart of a process for generating a mixing recipe that the system of FIG. 1 may follow to mix the ingredients in the tank 12 (FIGS. 1-2B). Similar to the discussion of the process show in FIG. 3, the following discussion starts, arbitrarily, with the system 10 operating.

In one embodiment, at step 60, one touches the touch screen display to display the ten tanks 12 coupled with the system 10. Next, one touches a desired tank 12 on the display to start or stop a mixing recipe associated with the tank 12 for mixing the contents of the tank 12. Then, at step 62, one inputs one of the following commands by touching the touch screen where one of the appropriately labeled blocks are displayed:

Start Mixing Recipe to Mix Contents of Tank; and

Stop Mixing Recipe for Mixing Contents of Tank.

If one desires to start a mixing recipe associated with the tank 12, then at step 62 one inputs the Start Mixing Recipe to Mix Contents of Tank. Next, at step 86, one decides if one wants to modify the current mixing recipe or start the current mixing recipe. If one wants to modify the current mixing recipe, then at step 88 one inputs a Modify Mixing Recipe command by touching the touch screen where the appropriately labeled block is displayed. Then at step 90, one inputs the desired duration of the pulse cycle by touching the touch screen where the appropriately labeled block is displayed. Then one decides if one wants to start mixing the contents of the tank 12. If yes, then at step 92 one instructs the controller 16 (FIGS. 1 and 3) to open and close the injector 14 (FIG. 1) according to the injection time and pulse rate associated with the tank 12 by touching the touch screen where the appropriately labeled block is displayed. If no, then at step 94 one associates the mixing recipe with the tank by touching the touch screen where the appropriately labeled block is displayed.

If at step 86 one decides to start the current mixing recipe, then at step 96 one instructs the controller 16 to open and close the injector 14 according to the injection time and pulse rate associated with the tank 12 by touching the touch screen where the appropriately labeled block is displayed.

Still referring to FIG. 5, if one wants to stop the mixing recipe currently associated with the tank 12, then at step 62 one inputs the Stop Mixing Recipe for Mixing Contents of Tank command by touching the touch screen where the appropriately labeled block is displayed. The controller 16 will then stop running the mixing recipe associated with the tank 12. If the controller 16 is currently opening and closing the injector 14 to generate a pulse cycle in the tank 12 when the Stop Mixing Receipt command is inputted, the controller 16 will stop opening and closing the injector 14.

1. A system for automatically mixing contents in a tank, the system comprising:
an injector operable to inject gas into the tank to form a bubble operable to mix the contents by moving through the contents;
a source of gas to supply the injector; and
a controller operable to open and close the injector and including:
a memory operable to store a mixing recipe that includes instructions for opening and closing the injector, and
a processor operable to retrieve the mixing recipe from the memory and open and close the injector according to the mixing recipe's instructions.

2. A system for breaking a cap generated during vinification, the system comprising:
an injector operable to inject gas into a tank containing fruit skins and other ingredients to form a bubble operable to break the cap and mix the ingredients;
a source of gas to supply the injector; and
a controller operable to open and close the injector and including:
a memory operable to store a mixing recipe that includes instructions for opening and closing the injector, and
a processor operable to retrieve the mixing recipe from the memory, and open and close the injector according to the mixing recipe's instructions.

3. The system of claim 2 wherein two or more injectors each are operable to inject gas into a respective one of the same number of tanks, and the controller is operable to open and close each injector.

4. The system of claim 3 wherein the controller is operable to open and close each injector according to one of a plurality of mixing recipes stored in the controller's memory.

5. The system of claim 3 wherein the controller is operable to open and close two or more injectors according to the same mixing recipe.

6. The system of claim 2:
wherein the injector is located outside the tank, and
the system further comprises a check valve coupled with the injector and operable to release gas from the injector into the tank and prevent the ingredients from entering the injector.

7. The system of claim 2 wherein the mixing recipe includes instructions for opening and closing the injector, repeatedly, to generate a pulse cycle in the tank.

8. The system of claim 7 wherein the mixing recipe includes instructions for opening the injector for a predetermined duration during a pulse of the pulse cycle.

9. The system of claim 7 wherein the mixing recipe includes instructions for closing the injector for a predetermined duration between pulses of the pulse cycle.

10. The system of claim 7 wherein the mixing recipe includes instructions for starting the pulse cycle at a predetermined time and stopping the pulse cycle at another predetermined time.

11. The system of claim 2 further comprising a pressure regulator operable to control the air pressure supplied to the injector.

12. The system of claim 2 wherein the controller includes a display operable to show the processor's progress through the mixing recipe, and to allow one to provide the controller data to modify the system's process for breaking the cap.

13. A method for making wine, the method comprising:
injecting gas into a tank containing ingredients for making wine to form a bubble; and
moving the bubble through the ingredients to mix the ingredients.

14. The method of claim 13 further comprising:
shearing a surface of a cap generated during vinification with the flows generated, to break the cap.

15. A method for making wine, the method comprising:
injecting gas into a tank containing fruit skins and other ingredients to form a bubble; and
colliding the bubble into a cap generated during vinification to break the cap.

16. The method of claim 15 wherein injecting gas into the tank includes opening and closing an injector with a processor of a controller according to instructions included in a mixing recipe.

17. The method of claim 15 wherein injecting gas includes generating a pulse cycle in the tank by opening and closing an injector, repeatedly, with a processor of a controller according to instructions included in a mixing recipe.

18. The method of claim 15 wherein colliding the bubble into the cap includes the bubble penetrating the cap to break the cap.

19. The method of claim 15 wherein colliding the bubble into the cap includes the bubble moving across the cap to break the cap.

20. The method of claim 15 further comprising moving the bubble through the ingredients to mix the ingredients.

21. The method of claim 15 further comprising:
adding an ingredient to the ingredients in the tank; and
moving the bubble through the ingredients to disperse the added ingredient.
